(19) United States
(12) Patent Application Publication
(10) Pub. No.: US 2008/0302613 A1
(43) Pub. Date: Dec. 11, 2008

(54) Wheel-and-brake assembly for aircraft

(75) Inventor: Jean Souetre, Boulogne (FR)

Correspondence Address: SUGHRUE MION, PLLC, 2100 PENNSYLVANIA AVENUE, N.W., SUITE 800, WASHINGTON, DC, 20037, US

(73) Assignee: MESSIER-BUGATTI, Velizy Villacoublay (FR)

(21) Appl. No.: 11/878,821

(22) Filed: Jul. 27, 2007

(30) Foreign Application Priority Data
Jun. 5, 2007 (FR) 0704022

(51) Int. Cl. F16D 55/36

(52) U.S. Cl. 188/71.5

(57) ABSTRACT

The invention relates to a wheel-and-brake assembly for an aircraft, the assembly comprising:
a wheel having a rim for mounting on an aircraft axle; and
a brake comprising a stack of disks with alternating stator disks that are stationary in rotation and rotor disks mounted to rotate with the wheel.

According to the invention, the assembly comprises a drum extending around the disks to be interposed between the disks and the rim, the drum including drive means for driving the rotor disks in rotation and fastener means for fastening the drum to the rim of the wheel.

The invention relates to a wheel-and-brake assembly for aircraft.

### BACKGROUND OF THE INVENTION

Brakes are known that comprise a stack of disks made up of rotor disks and stator disks that generally extend inside the rim within the associated wheel. The rotor disks are usually constrained to rotate with the rim by means of keys or splines.

Presently-envisaged aircraft require brakes to be provided having disks either of increasing thickness or of increasing number so that the disks can no longer be received entirely within the wheel rim. A problem then arises with driving those rotor disks that lie outside the rim in rotation with the wheel. To do this, an immediate solution consists in lengthening the keys so that they project outside the rim in an axial direction. With such an arrangement, the keys are then cantilevered out from the rim and are thus subjected to bending forces which run the risk of breaking the keys. To remedy that problem, it is possible to reinforce the keys by enlarging them, thereby entraining the drawback of increasing the weight and the complexity of the brake assembly. In particular, it becomes difficult to envisage keys that are made integrally with the rim, and it becomes necessary to fit on keys so that they are secured at at least two points along their length, with an inevitable cantilevered-out end portion projecting from the rim.

### OBJECT OF THE INVENTION

An object of the invention is to provide a wheel-and-brake assembly that enables rotor disks lying outside the rim to be driven in rotation while avoiding the above-mentioned drawbacks.

### BRIEF DESCRIPTION OF THE INVENTION

The invention provides more particularly a wheel-and-brake assembly for aircraft comprising a wheel comprising a rim for mounting to rotate on an aircraft axle, and a brake comprising a stack of disks, including stator disks that are stationary in rotation and rotor disks that are driven to rotation together with the wheel.

According to the invention, the assembly comprises a drum extending around the disks to be interposed between the disks and the rim and that includes firstly drive means for driving the rotor disks in rotation, and secondly fastener means for fastening the drum to the wheel rim.

The drum thus forms an intermediate element between the rotor disks and the rim, enabling the braking torque generated by friction between the disks to be transmitted to the rim.

The drum presents a large amount of twisting stiffness so that even if it extends to drive disks that are situated well outside the rim, the braking toque generated by those disks and transmitted to the drum is taken up by the drum and transmitted thereby to the rim without the drum suffering large amounts of deformation, unlike keys fastened to the rim and cantilevered out therefrom. This large amount of twisting stiffness makes it possible to envisage connecting the drum to the rim in such a manner that the drum is connected by bolts extending along diameters of the drum, and distributed around a single circumferential line.

### BRIEF DESCRIPTION OF THE DRAWINGS

The invention can be better understood in the light of the following description with reference to the figures of the accompanying drawings, in which:

FIG. 1 is a section view showing a wheel-and-brake assembly of the invention with a drum; and

FIG. 2 is a diagrammatic perspective view showing an assembly comprising the rim and the drum of FIG. 1.

### DESCRIPTION OF THE INVENTION

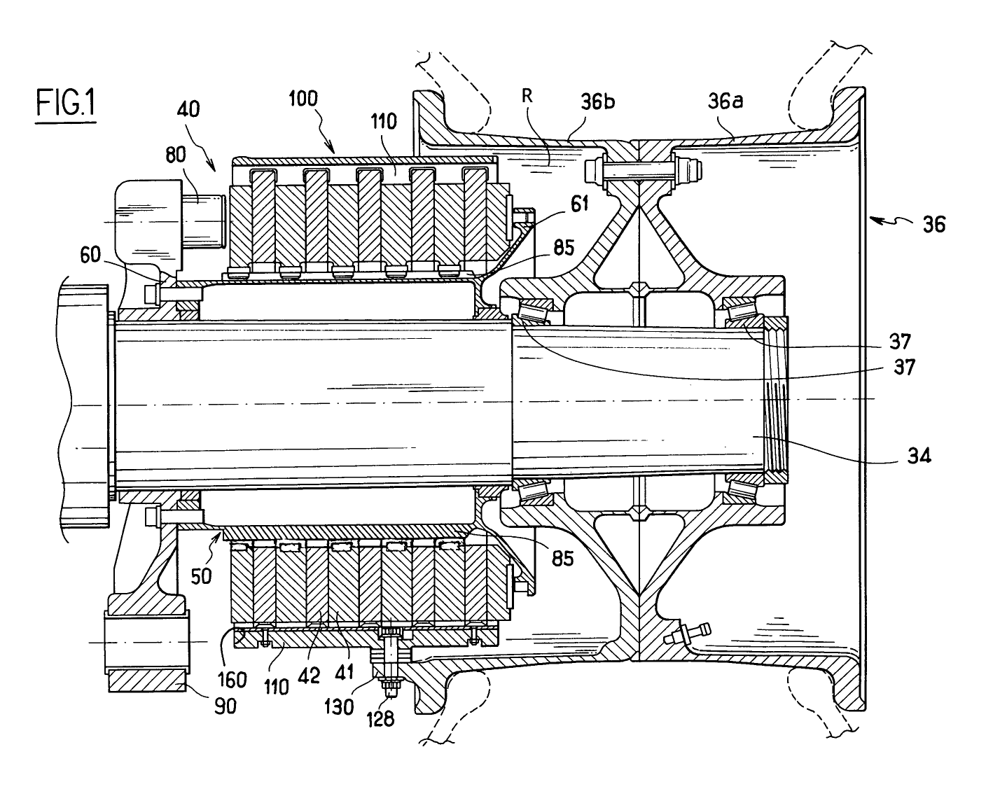

With reference to FIG. 1, the wheel-and-brake assembly of the invention is shown mounted on an undercarriage axle 34. The assembly includes a wheel 36, comprising a rim, here made up of two half-rims 36a, 36b, and rotatably mounted on the axle 34 by means of conical roller bearings 37. The rim is for receiving a tire (represented symbolically by dashed lines).

The assembly also includes a brake 40 comprising a torsion tube 50 that is engaged around the axle 34. The torsion tube 50 is secured to a ring 60 that includes a torque-takeup fitting 90 that co-operates with a torque-takeup catch or bar (not shown) to prevent the torsion tube 50 from turning about the axle 34. The ring 60 carries brake actuators 80, in this example hydraulic pistons.

Disks are engaged on the torsion tube 50, the disks comprising in alternation stator disks 41 that are fixed in rotation relative to the torsion tube 50, and rotor disks 42 that are free to rotate relative to the torsion tube 50, and that rotate with the wheel 36 (only one disk of each category is referenced). The stator disks 41 are prevented from rotating relative to the torsion tube 50 by keys or splines 85 (one of which is visible in section in FIG. 1), which in this example are made integrally with the torsion tube.

At its end remote from the ring 60, the torsion tube 50 includes a braking force takeup member 61, in this example integrally formed with the torsion tube 50. When the actuators 80 are operated, the stack of disks comes to bear against the force takeup member 61, thereby enabling the actuators to exert pressure on the stack of disks.

The rim, the disks, and the torsion tube extend coaxially about the axis of rotation X of the wheel as defined by the axle 34.

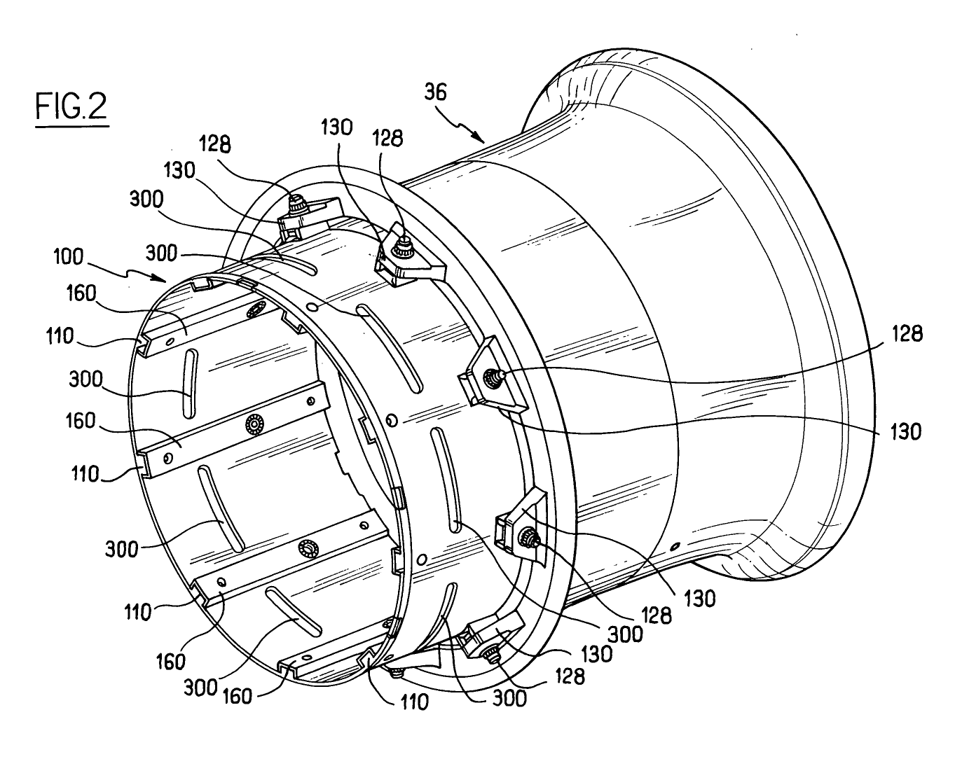

In the invention, the disks are surrounded by a drum 100 that is generally circularly cylindrical in shape and that includes keys or splines 110 extending inside the drum 100 to drive the rotor disks in rotation. In this example, the keys 110 are made integrally with the drum 100. One of them can be seen in section in FIG. 1. Bolts 128 extend through the drum, in this case through the keys 110 so as to penetrate into lateral projections 130 of the half-rim 36b in order to secure the drum 100 to the rim 36. As can be seen more particularly in FIG. 2, the bolts 128 extend along a circumferential line of the drum 100, thereby forming a single line of bolts that thus extends in a plane perpendicular to the axis X. Such a connection between the drum and the rim is sufficient to transmit braking torque to the rim 36 effectively, given the high degree of twisting stiffness of the drum 100.

As can be seen more particularly in FIG. 2, protective sheets 160 cover the keys 110 of the drum 100 and are secured to the keys 110 by bolts.

The assembly of the invention operates as follows: pressure is applied to the disks by means of the actuators 80. The rotor disks 42 rub against the stator disks 41. The stator disks 41 are prevented from rotating on the torsion tube and they brake the rotor disks 42 by generating braking torque. This braking torque is transmitted by the rotor disks 42 via the keys 110 to the drum 100, and then via the bolts 128 to the rim 36, thereby braking the wheel.

As can be seen particularly clearly in FIG. 1, the stack of disks does not extend entirely within the rim 36 of the wheel, but extends at least in part outside the rim, such that the drum 100 extends at least in part outside the rim. Nevertheless, the drum 100 presents twisting stiffness that enables the torque generated by the rotor disks, including those that lie outside the rim 36, to be transmitted without the drum suffering a large amount of deformation.

The use of a drum thus enables very long stacks of disks to be installed that can project outside the rim. If, as in this example, the stack of disks is remote from the central web of the rim, the half-rims 36a, 36b can then be designed to be substantially symmetrical, thereby reducing the cost price of the wheel, and enabling it to work under better conditions, thereby enabling weight to be saved. In addition, the disks are easier to cool because of a space R extending between the stack of disks and the web of the rim. For this purpose, and as can be seen in FIG. 2, the drum 100 is advantageously provided with orifices 300 enabling the disks to be ventilated. In this example, the ventilation orifices are oblong and disposed in a circumferential row.

Finally, the fact that the pile of disks is remote from the rim limits the extent to which the rim is heated when the disks heat up. This disposition thus makes it possible to subject the disks of the brake to higher temperatures, while retaining the same acceptable temperature for the rim and the tire it carries. The possibility of the disks reaching temperatures that are higher than those that would be permissible if the stack of disks extending essentially inside the rim serves to reduce the weight of the brake disks, thereby achieving significant savings.

During maintenance of the wheel-and-brake assembly of the invention, it should be observed that the rim and the drum are connected together so that they can be handled as though they formed a unitary assembly suitable for dismantling as a single piece, as is shown more particularly in FIG. 2. The drum 100 is connected to the rotor disks 42 solely via the keys 110, thus enabling the drum 100 to move axially relative to the disks, so it is entirely possible to withdraw the wheel and the drum simultaneously.

Such a drum is preferably made of aluminum, having a coefficient of expansion that is close to the material used for making the rims. The drum 100 works in twisting only, is of large diameter, and is not subjected to the braking forces delivered by the actuators. There is thus, a priori, no need to use a material of higher performance, and thus greater expense, such as titanium.

The invention is not limited to the above description, but on the contrary covers any variant coming within the ambit of the claims.

In particular, although the drive means in the example shown for driving the rotor disks 42 by means of the drum 100 are constituted by keys 110 formed integrally with the drum 100, it is possible to use other drive means. For example, the keys 110 could be fitted to the drum 100. The keys 110 could also be welded to the drum 100.

Similarly, although the means for fastening the drum to the rim are shown as being constituted by bolts extending through the keys and lying on a circumferential line, the invention is not restricted to this particular form of connection, and variants are possible within the ambit of the invention:

the bolts may extend over a plurality of circumferential rows, e.g. in a zigzag configuration relative to one another;

the bolts may pass through the drum other than through the keys; and

the drum may be riveted or welded to the rim.

What is claimed is:

1. A wheel-and-brake assembly for aircraft, the assembly comprising:
a wheel having a rim for mounting on an aircraft axle; and
a brake comprising a stack of disks extending coaxially about the axis of the wheel, with alternating stator disks that are stationary in rotation and rotor disks that are driven to rotate with the wheel,
the assembly including a drum extending around the disks for interposing between the disks and the rim, the drum having drive means for driving the rotor disks in rotation and fastener means for fastening the drum to the rim of the wheel.

2. An assembly according to claim 1, in which the drum extends at least in part outside the rim.

3. An assembly according to claim 1, in which the drive means comprise keys extending inside the drum to co-operate with the rotor disks.

4. An assembly according to claim 3, in which the keys are made integrally with the drum.

5. An assembly according to claim 1, in which the means for fastening the drum to the rim comprise bolts extending through the drum to penetrate into lateral projections from the rim, the bolts extending along diametral lines in a plane perpendicular to a central axis of the assembly.

6. An assembly according to claim 5, in which the drum includes keys on its inside surface for driving the rotor disks in rotation with the drum, the bolts for fastening the drum to the rim extending through said keys.

7. An assembly according to claim 1, in which the drum is fastened to the rim so as to form a unitary assembly that can be removed as a single piece.

8. An assembly according to claim 1, in which the drum includes ventilation orifices.
